(19) United States
(12) Patent Application Publication
(10) Pub. No.: US 2004/0224703 A1
(43) Pub. Date: Nov. 11, 2004

(54) Method and system for enhancing venue participation by venue participants

(76) Inventors: Steven M. Takaki, Glenview, IL (US); John D. Bruner, South Barrington, IL (US); Steve R. Bunch, Harvard, IL (US); Ronald J. Schmidt, Grayslake, IL (US)

Correspondence Address: VEDDER PRICE KAUFMAN & KAMMHOLZ, 222 N. LASALLE STREET, CHICAGO, IL, 60601, US

(21) Appl. No.: 10/435,269

(22) Filed: May 9, 2003

(51) Int. Cl. H04Q 7/20

(52) U.S. Cl. 455/457; 455/456.1

(57) ABSTRACT

A method and system for enhancing venue participation provides venue information to participants. The system includes a network element (14) and a plurality of wireless devices (10). The wireless device (10) includes a controller (30) operative to receive venue participant-based optimization data (42) and venue-specific map data (44). The venue participant-based optimization data (42) is associated with at least the venue-specific map data (44), and the venue-specific map data (44) is associated with at least wireless device location data (46). The controller (30) is operative to display the venue participant-based optimization data (42) and the venue-specific map data (44) data on a display (34).

### FIELD OF INVENTION

The invention relates generally to map-based information systems and, more particularly, to map-based location information systems.

### BACKGROUND OF THE INVENTION

Public places of interest, or venues, such as amusement parks, museums, convention centers, zoos, campuses, and shopping malls, often have multiple attractions, restaurants, shops, and rides, for example, that are available for use by the participants at the venue. The venue may be within a defined area, such as, for example, an amusement park, a museum, a convention center, a zoo, a campus, a shopping mall, or any suitable event. Since large crowds of people are often attracted during certain periods of time to some attractions, including restaurants and shops at the venue, the queue wait-times at those attractions tend to be long, while the queue wait times at other less crowded attractions tend to be considerably less. Currently, it is difficult to obtain information, such as the real-time status of an attraction, or the queue wait time at a ride, restaurant, or shop, because such information is often not available to participants. For example, paper maps provided by the amusement park do not provide current queue wait time information about a specific attraction. Also, the location of an attraction and the route with the least amount of traffic from one attraction to another is difficult to determine without knowing the current traffic flows in the venue. Additionally, it is often difficult or time-consuming to determine one's current location in a large, crowded and unfamiliar venue. Information such as the condition or status of an attraction, or information such as an incentive to visit a particular attraction or place at the venue, may enhance traffic flow within a venue, enhance participant enjoyment of the venue and, consequently, may enhance revenue for the venue operator.

Navigation systems, such as GPS (global positioning system)-based navigation systems, are known to provide location information relative to a displayed map. These systems typically indicate the position of the navigation system on a street map to facilitate navigation of streets while driving a car. Similarly, these navigation systems are useful as handheld units to facilitate walking, jogging or hiking. These systems may provide travel information, such as gas station location, hotel, and restaurant location information. This travel information may be integrated into the display map in these navigation systems. Navigation systems with such capability often permit the travel information to be updated through a CD or DVD as new travel information becomes available and is distributed.

However, these navigation systems do not provide venue-related attraction and condition information (e.g., real-time ride wait times, etc.). Additionally, the maps of these systems are typically updated approximately every six to twelve months with new street and travel information, and may require the installation of a CD or DVD into the navigation system to perform the update. Furthermore, these navigation systems are relatively expensive to update.

A user browsing the Web may access map information over the Internet. For example, a laptop computer or handheld device may access the Internet using, for example, a Wireless Application Protocol (WAP) interface. However, these map browsers are limited to receiving street-level map information, and do not typically provide for the display of venue-specific conditions. For example, the map information provided over the Internet typically does not include real-time information about the venue.

### BRIEF DESCRIPTION OF THE DRAWINGS

The present invention is illustrated by way of example and not limitation in the accompanying figures in which like-referenced numerals indicate similar elements, and in which:

FIG. 1 is a block diagram of a system for enhancing venue participation, in accordance with the preferred embodiment of the present invention;

FIG. 2 is a flow chart illustrating a method for enhancing venue participation from the perspective of a wireless device, in accordance with one embodiment of the present invention;

FIG. 3 is a flow chart of a method for sending user-specific information to enhance venue participation by venue participants according to one embodiment of the invention;

FIG. 4 is a flow chart of a method for updating and displaying data to enhance venue participation by venue participants according to one embodiment;

FIG. 5 is a block diagram of a wireless device according to one embodiment;

FIG. 6 is a flow chart of a method for registering a user according to one embodiment;

FIG. 7 is a method for generating venue participant-based optimization data according to one embodiment; and

FIG. 8 is a method for selecting a desired level of service to enhance venue participation according to one embodiment.

### DETAILED DESCRIPTION OF THE PREFERRED EMBODIMENT

A method and system for enhancing venue participation provides venue and map information to participants. A wireless device includes a controller operative to receive venue participant-based optimization data, such as attraction wait times or a restaurant coupon, and venue-specific map data, such as a static map of the attractions in the venue from a network element. The venue participant-based optimization data is associated with at least venue-specific map data. For example, the venue participant-based optimization data may be a coupon logically associated with a restaurant in the area of the venue in which the wireless device is currently located, or alternatively the coupon may be associated with a restaurant in an area outside of the area of the venue that the wireless device is currently located. The venue-specific map data is associated with at least wireless device location data, such as the position of the wireless device relative to the venue map. For example, the position of the wireless device relative to the venue map may be used to identify or associate the appropriate venue map, such as a map indicating the current, future, or past position of the wireless device. The venue participant-based optimization data may be logically associated with the venue map, or a section of the venue map in order to provide information about the venue to the wireless device, such as ride wait times and restaurant or shopping coupons. The controller is operative to display the venue participant-based optimization data and the venue-specific map data on a display.

The network element includes a venue participant-based optimization generator and map provider that utilizes optimization rule information to generate the venue participant-based optimization data, based on at least real-time venue participant data and wireless device location data. The venue participant-based optimization data generator and map provider is operatively coupled to receive real-time venue participant data from a venue participant data provider, and venue-specific map data from a venue-specific map database. Accordingly, the venue participant-based optimization data generator and map provider determines venue-specific map data based on received wireless device location data sent by the wireless device. Further, the database associates the wireless device location data and the venue-specific map data with venue participant-based optimization data, based on, for example, a link list or a relational database link. The database may associate a map, represented by venue-specific map data, with a location in the venue represented by wireless device location data based on a link list or relational database link.

The method and system for enhancing venue participation by venue participants may benefit participants by providing them venue information regarding, for example, the queue wait times for various attractions, such as rides, and incentive data, such as coupons. The venue information provides valuable information about the venue to the participants to permit the participants to identify the attractions, such as shops and restaurants that are of most interest, thereby providing the participants with the maximum enjoyment of the venue. Additionally, the operator of the system may optimize any parameter desired, such as maximizing revenue, traffic flow or any suitable venue parameter, as desired. Accordingly, the system may provide the participants with real-time information, such as queue wait times, directions, location and electronic coupons, that would be useful and beneficial to both operators and participants during the participants' visit to the venue.

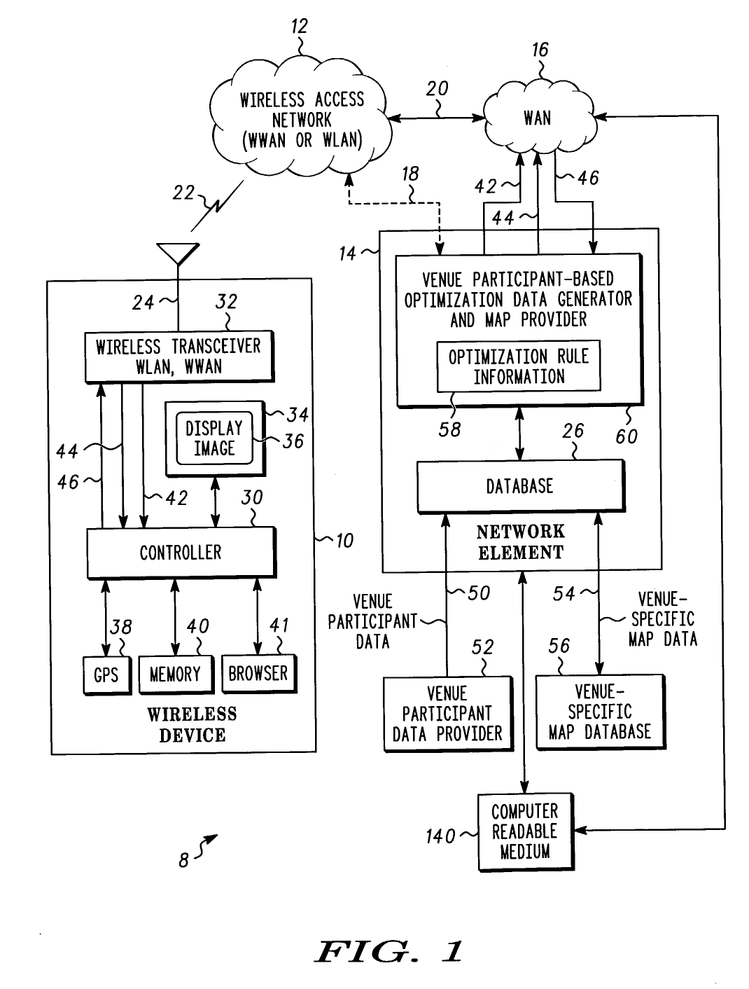

FIG. 1 is a block diagram illustrating one example of a system 8 for enhancing venue participation by venue participants. As used herein, venue includes any suitable amusement park, museum, convention center, zoo, shopping mall, campus or any other suitably defined area. The system 8 employs a plurality of wireless devices 10 operatively coupled to at least one network element 14 via a wide-area network 16, such as the Internet, and a wireless wide access network (WWAN) or wireless local area network 12 (WLAN).

The wireless device 10 may be any device capable of communication with wireless access network 12, including, but not limited to, a cell phone, a laptop computer, a personal digital assistant (PDA), a GPS circuit, a smart phone, or any other suitable device, as recognized by one having ordinary skill in the art suitable to enhance venue participation by venue participants. According to one exemplary embodiment, the wireless device 10 is a mobile phone operating as a PCS (Personal Communications Service) or iDEN (Integrated Dispatch Enhanced Network) device that operates, or is supported by a GPS receiver 38 to obtain location data and a bluetooth interface to operate with a bluetooth wireless network. The GPS receiver 38 provides controller 30 with location data associated with the location of the wireless device, for example, within the venue.

Wireless access network 12 may be a wireless wide-area network (WWAN), such as a CDMA, TDMA, 3G, PCS, iDEN, or any suitable wireless type of communication network. Alternatively, wireless access network 12 may be a wireless local access network (WLAN), such as a bluetooth network, 802.11(b) network, or any other suitable short-range communication network. Wireless access network 16 may be operatively coupled with wireless access network 12 via a suitable communication link 20. Alternatively, network element 14 may interface with wireless access network 12 through a suitable direct connection 18.

Wireless device 10 includes controller 30 operatively coupled to a wireless transceiver 32, a display 34 for presenting display image 36, a GPS receiver 38, memory storage 40 and browser 41. Controller 30 is operative to receive venue participant-based optimization data 42 and venue-specific map data 44, as provided by network element 14. The venue participant-based optimization data 42 may be real-time ride wait data or coupons associated with the venue attractions, such as the rides, restaurants, and shops in the map area, or outside the map area represented by the venue-specific map data 44. Venue participant-based optimization data 42 represents real-time or non-real-time information such as venue attraction data for display on display 34 to effect participant flow within a venue. For example, the venue participant-based optimization data 42 may be real-time queue wait data, delayed queue wait time data, direction data, location data, traffic data, coupon data, advertising data, emergency message data, venue attraction data, or any other suitable data. According to one exemplary embodiment, a venue, such as an amusement park, may have attractions, such as rides, having associated queue wait times. The queue wait times may be provided to the wireless device 10 based on venue participant data 50 received from network element 14. Venue participant data 50 may represent real-time information about attractions in the venue, such as, for example, the queue wait times for restaurants and rides at an amusement park. For example, controller 30 may dynamically update the venue participant-based optimization data 42 that is displayed, based on real-time changes of the venue participant data 50. Accordingly, venue participant-based optimization data 42 may be generated to provide incentive data based on the conditions of the attractions, as specified by venue participant data 50. In accordance with a preferred embodiment, venue participant-based optimization data 42, such as real-time queue wait times, may be dynamically transmitted from the network element 14 to the wireless device 10 via WAN 16, and the wireless access network, using text-based messaging, such as a Short Message Service (SMS), to provide updates to the user on a dynamic basis.

The venue-specific map data 44 is associated with at least wireless location data 46. The venue-specific map data 44 may be, for example, amusement park map data, museum map data, convention center map data, zoo map data, campus map data, or any suitable map data specific to a given venue. The venue-specific map data 44 may be a map of a venue or a portion of a venue that is displayed in segments, such that as the wireless device 10 moves about the venue, the appropriate section of the map is displayed corresponding to the location of the wireless device within the venue 10. In one embodiment, the venue participant-based optimization data 42 provides incentive data, such as coupons for a restaurant, that is displayed in combination with the venue-specific map data 44.

Accordingly, the appropriate venue-specific map data 44 may be determined based on at least wireless location data 46. The wireless device location data 46 may be obtained by a local GPS receiver, a triangulation technique used by the radio access network, or any other suitable device for obtaining location information.

The controller 30 is operative to display the venue participant-based optimization data 42 and the venue-specific map data 44 on the display 34. In one embodiment, controller 30 dynamically updates the venue participant-based optimization data 42 that is displayed, based on real-time changes of venue participant data 50, such as the queue wait times of all or some of the rides at the venue. The venue-specific map data 44 may or may not be updated on display 34 at the same time the venue participant-based optimization data 42 is updated.

The controller 30 may be, for example, one or more suitably programmed microprocessors, microcontrollers, DSPs (digital signal processor), or other processing circuitry, and may include associated memory that contains executable instructions that, when executed, causes the controller 30 to carry out the operations described herein. In addition, controller 30, as used herein, includes discrete logic, state machines, or any other suitable combination of hardware, software and/or firmware. In this example, controller 30 includes at least one processing device, such as a microprocessor, and associated storage 40, having stored therein instructions executable by the at least one processing device that causes the processing device to perform the functions described.

Controller 30, as previously stated, is also operably coupled to wireless transceiver 32 to receive the venue-specific map data 44 and the venue participant-based optimization data 42. Controller 30 provides wireless device location data 46 to network element 14 so that the network element 14 can determine the appropriate map data to send to the wireless device 10 and so that the network element 14 can determine the appropriate venue participant-based optimization data to send. Wireless transceiver 32 may function in compliance with any wireless air interface standard, such as bluetooth, CDMA, TDMA, 3G, and any suitable wireless air interface standard. Controller 30 is also operatively coupled to browser 41, storage 40 and GPS 38. According to one embodiment, wireless transceiver 32 represents two transceivers and two antennas. For example, one wireless transceiver may be a WWAN transceiver to receive SMS data, such as venue-specific map data 44, and a second transceiver may be a WLAN transceiver compliant with the bluetooth standard to receive map data representing message data, such as venue participant-based optimization data 42. For example, transceiver 32 may be either a WWAN or a WLAN to receive both.

Network element 14 includes a venue participant-based optimization generator and map provider 60 that utilizes optimization rule information 58 to generate the venue participant-based optimization data 42, based on at least real-time venue participant data 50 and wireless device location data 46. Venue participant-based optimization data generator and map provider 60 is operatively coupled to receive real-time venue participant data 50 from venue participant data provider 52, and venue-specific map data 54 from venue-specific map database 56 either directly or indirectly through, for example, database 26. For example, database 26 may associate a map, represented by venue-specific map data 44, with a location in the venue, represented by wireless device location data 46, based on a link list or relational database link. Accordingly, the venue participant-based optimization data generator and map provider 60 determines venue-specific map data 44 based on received wireless device location data 46 sent by the wireless device 10. Further, database 56 associates the wireless device location data 46 and the venue-specific map data 44 with venue participant-based optimization data 42, based on, for example, a link list or relational database link.

In one embodiment, controller 30 dynamically updates the venue participant-based optimization data 42 that is displayed, based on real-time changes of venue participant data 50, while the venue-specific map data 44 is not updated on the display. For example, the venue participant-based optimization data 42 represents real-time incentive data, such as coupons to restaurants and venue attraction information (i.e., ride wait times), displayed on the display 34 to effect participant flow within a venue. According to one embodiment, the controller provides venue participant-based optimization data 42 and venue-specific map data 44 on separate sections of display 34, as superimposed data images with respect to one another, or periodically alternating data images on the display 34.

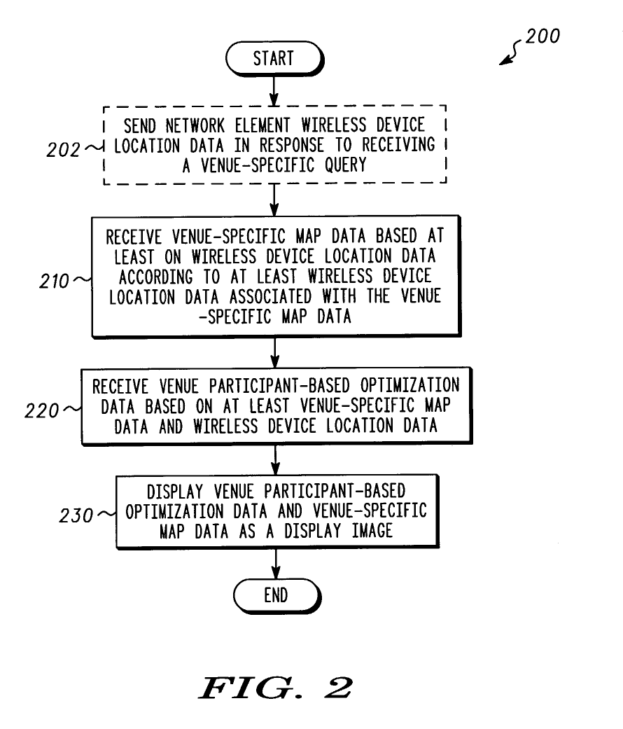

FIG. 2 is a flow chart of a method 200 for enhancing venue participation by venue participants on a wireless device 10 according to one exemplary embodiment. Wireless device 10 sends wireless device location data 46 to network element 14 at block 202 in response to receiving a venue-specific query from network element 14. Wireless device 10 receives venue-specific map data 44 at block 210 based at least on the wireless device location data 46 that was sent. At block 220, wireless device 10 receives venue participant-based optimization data 42 from network element 14. The controller causes display 34 to display the venue-specific map data 44 and the venue participant-based optimization data 42 at block 230. In one embodiment, controller 30 dynamically updates display image 34 with updated venue participant-based optimization data 42 based on real-time changes of venue participant data 50 while the venue-specific map data 44 is not updated on display image 34. As previously stated, the venue participant-based optimization data 42 may represent real-time incentive data such as coupons for restaurants and shops and non-real-time incentive data on display 34 to effect participant traffic flow within the venue.

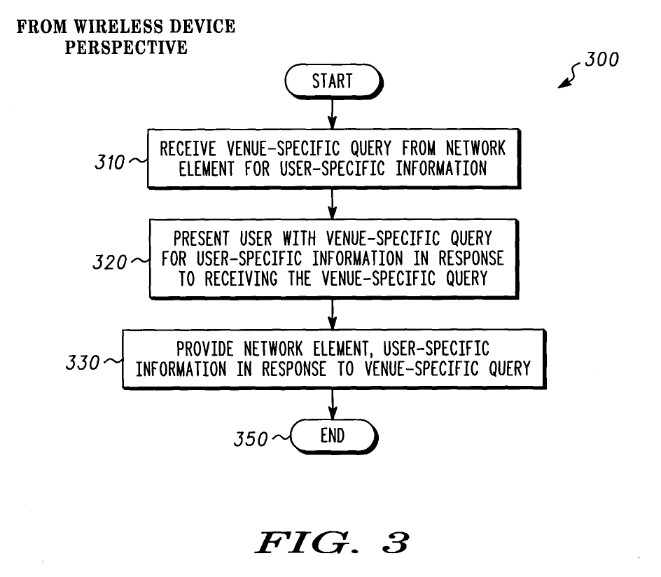

FIG. 3 is a flow chart illustrating a method 300 for providing user-specific information from wireless device 10 to network element 14 according to one exemplary embodiment. Wireless device 10 receives a venue-specific query from network element 14 to obtain user-specific information at block 310. Wireless device 10 presents the user with a venue-specific query as a greeting and prompt, in order to obtain user-specific information at block 320. In response to the venue-specific query, wireless device 10 provides network element 14 user-specific information at block 330 about the user, the participants in the party, and the wireless device 10. User-specific information may include user identification such as a user name or number, length of stay data for the party, the software version of the venue-specific map data 42, the map engine software version, payment method, level and type of security, number in the party, ages of participants, event preferences and other suitable demographics data.

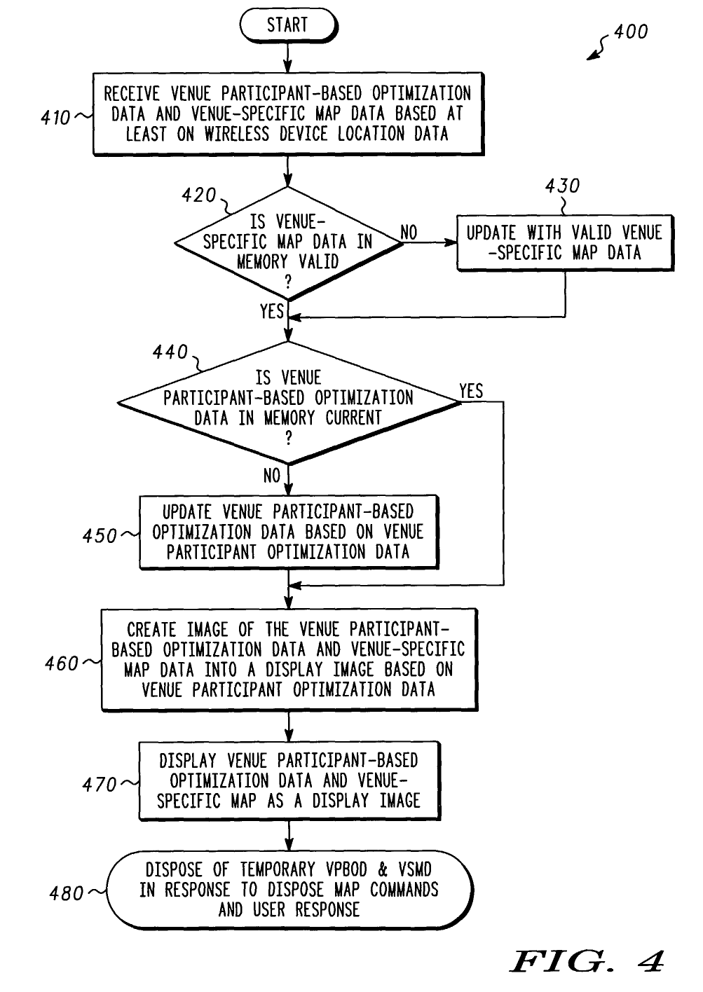

FIG. 4 is a block diagram 400 for updating and displaying the venue participant-based optimization data 42 and venue-specific map data 44. As shown in block 410, wireless device 10 receives venue participant-based optimization data 42 and venue-specific map data 44 as previously discussed in detail based at least on wireless device location data 46. The venue-specific map data 44 may be a map of the venue or sections of a map of a venue, such as when zooming-in or out of a map to provide localized map information on display 34. Accordingly, the appropriate map or section of the map is determined based on the wireless device location 46 and, as a result, the appropriate venue-specific map data 44 is determined by the network 14, as previously discussed. Once the venue-specific map data 44 is determined, then the venue participant-based optimization data 42 associated with the venue-specific map data 44 may be provided based on, for example, the condition or status of attractions as identified in the venue participant data 50.

Wireless device 10 updates storage 40 with venue-specific map data 44 if storage 40 does not have valid venue-specific map data 44 at blocks 420 and 430. For example, if the wireless device 10 has changed from its previous location into a different venue-specific map data area, then new venue-specific map data 44 will be received. At step 450, storage 40 is updated with venue participant-based optimization data 42 if storage 40 does not have valid venue participant-based optimization data 42.

As shown in block 450, the venue participant optimization data 42 and the venue-specific map data 44 may be dynamically updated based on real-time changes of the venue participant data 50. If the user does not leave the current map area, the wireless device location data 46 indicates the user has not left the map area and, as a result, no new venue-specific map data 44 is required. However, dynamic changes in the status of attractions represented by dynamic changes in venue participant data 50 result in venue participant-based optimization data 42 changing dynamically. If the venue-specific map data 44 is updated because, for example, the wireless device location data 46 indicates that the wireless device 10 is in a new map area, then storage 40 is updated with venue participant-based optimization data 42.

Controller 30 will then create display image 36 at block 460 in accordance with the various data to be displayed and in a desired format. The various data may be displayed in any format, such as in separate display areas, data overlays, and alternating the display of the various data. Controller 30 sends the display image 36 to display the updated venue participant-based optimization data 42 and the venue-specific map data 44 at block 470. In one embodiment, the controller 30 updates the portion of the display image 36 with respect to the dynamically changed venue participant-based optimization data 42 where the venue-specific map data 44 remains unchanged. As previously discussed, the venue-specific map data 44 and the venue participant-based optimization data 42 may be displayed on separate sections of display image 36, or alternatively venue participant-based optimization data 42 may be superimposed over venue-specific map data 44. For example, display image 36 alternates between venue-specific map data 44 and venue participant-based optimization data 42. The venue participant-based optimization data 42 may be a coupon for a restaurant, shop, or other attraction in order to provide an incentive for a participant to visit that particular attraction. In this embodiment, the coupon may be displayed on a separate area of display image 36 separate from the venue-specific map data 44. Alternatively, as previously discussed, the coupon could be superimposed over the map area, or the display image 36 may alternate between the coupon and the venue-specific map data 44.

In another embodiment the display image 36 has one or more visual attributes, such as color, a pattern, or a design. According to one embodiment, display image 36 displays the venue participant-based optimization data 42 and the venue-specific map data 44 in color where each color corresponds to a different venue activity. In one embodiment, the venue participant-based optimization data 42 provides queue-length times in different colors ranging from, for example, red, orange, yellow, green, blue, black, or white corresponding to the relative length of time for the queue wait time. Colors may be also used to attract attention to coupons or other promotional items in order to direct participants to attractions of interest. Additionally, the colors could be updated dynamically to attract attention. In the event that the wireless device 10 does not support color, a fixed pattern or predetermined set of patterns may be employed. Additionally, venue participant-based optimization data 42 may be presented as a sound, a sound loudness level, or a group of sounds, such as a voice message, a song, a tone, or a combination of tones. These sounds may be used to alert the venue participant of venue information, such as a change of an attraction or event.

In the event multiple messages or the venue participant-based optimization data 42 represents multiple display items, a predetermined rule may prioritize the data to be displayed. For example, if a coupon, an alert, or an emergency message is received, then this data may be displayed before other data, such as attraction status information.

Controller 30 may, if appropriate, dispose of the temporary venue participant-based optimization data 42 and the venue-specific map data 44 at block 480. For example, the controller 30 may dispose of the venue participant-based optimization data 42 and venue-specific map data 44 in response to receiving a disposed map command from network element 14 or in response to receiving a user-initiated disposed map command.

For example, if the user leaves the venue, the controller 30 may prompt the user to indicate whether the venue-specific map data 44 should be disposed from storage 40. As the wireless device 10 traverses the venue and moves from one map area to another area, updated venue-specific map data 44 will be dynamically sent to the wireless device 10. This data may be stored and accumulated in the storage 40. Similarly, venue participant-based optimization data 42 will be sent to the wireless device dynamically. For example, data sent dynamically may be sent in real-time as new data becomes available. This data may be automatically disposed of according to a predetermined method.

Since the wireless device 10 has a fixed amount of storage capacity available in storage 40, in order to insure that this storage capacity is available for new data, controller 30 may dispose data as shown in block 480 based on, for example, erasing the oldest data first, erasing the least used data first, or as directed by the network element 14, or based on a user-initiated response. In one embodiment, if a participant is interested in, for example, a coupon currently being displayed, the user may provide a user response indicating to the wireless device 10 not to delete the coupon after a predetermined period of time. In another embodiment, the participant may wish to have any venue-specific map data 44 erased after a period of time, such as, for example, one or two days after leaving the venue. Alternatively, the participant may direct controller 30 to maintain venue-specific map data 44 within wireless device 10 as a souvenir.

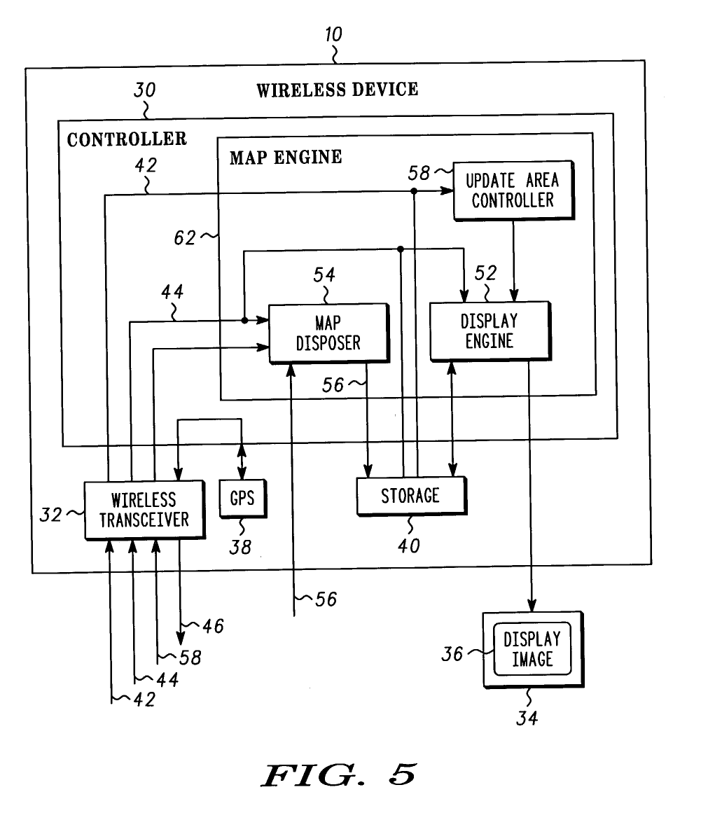

FIG. 5 is a block diagram of wireless device 10 of FIG. 1, shown in more detail. Wireless device 10 includes a controller 30, a wireless transceiver 32, a GPS circuit 38 and storage 40. Controller 30 also includes map engine 62 and is operatively coupled to wireless transceiver 32, storage 40 and display 34. Map engine 62 includes map disposer 54 for receiving venue participant-based optimization data 42 and venue-specific map data 44 from network element 14. Map engine 62 also includes update area controller 58 for receiving venue participant-based optimization data 42 and updating the display image 36, and display engine 52, and for generating display image 36 as previously discussed in detail. Map disposer 54 receives a user disposal response 44, for example, from the user of wireless device 10, or alternatively map disposer 54 receives a disposal command 58 from network element 14 as previously discussed. If disposal of data stored in storage 40 device is requested, the map disposer 54 sends an appropriate signal on an interface 56 between storage 40 and map disposer 54 to dispose of the data as appropriate in storage 40. Update area controller 58 receives venue participant-based optimization data 42 in order to facilitate dynamically updating display image 36 via display engine 52 as previously discussed. For example, update area controller 58 controls the display of the venue participant-based optimization data 42 and venue-specific map data 44 to produce display image 36, as previously stated for example, on separate areas of display image 36, as an overlay, or as alternating data.

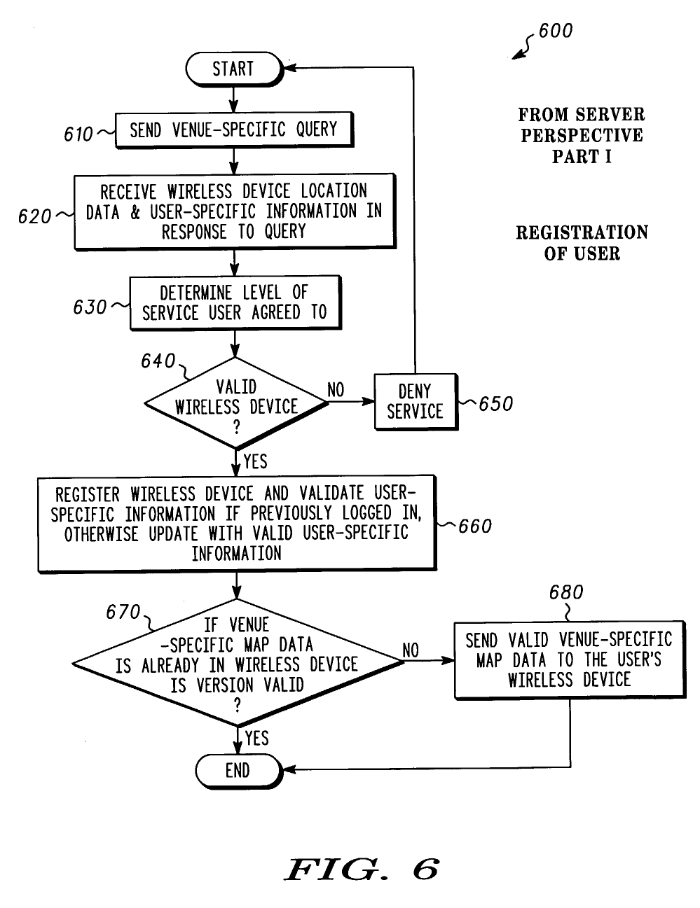

FIG. 6 is a method 600 of registering a user in the system 8 for enhancing venue participation by venue participants. At block 610, network element 14 sends a venue-specific query to wireless device 10. For example, when the wireless device 10 first enters the venue, the network element 14 sends the venue-specific query to wireless device 10 to, for example, alert the wireless device 10 that it has entered the coverage area of the system 8. The venue-specific query may also provide information to the user regarding the services available, information about the venue, and a query to the wireless device 10 for information.

At step 620, network element 14 receives wireless device location data 46 and user-specific information from wireless device 10 in response to the venue-specific query. The wireless device location data 46 may be provided by a GPS circuit 38, by a triangulation technique, or from the wireless access network based on the server communicating with wireless device 10 on the wireless access network. Any other suitable method or system for obtaining the location data of the wireless device 10 may be employed. The user-specific information, as previously discussed, provides information about the user such as the length of stay, the number of participants in the party, the ages of the members in the party, their event preferences, demographics data, venue-specific map data, software version data, map engine software version data, payment method, and security information. The user-specific information is used to generate, in part, the venue participant-based optimization data 42.

For example, the optimization rule employed by the venue participant-based optimization data generator and map provider 60 may use information about the participant, such as their age, so incentives can be provided appropriately and tailored to the participants. For example, participants or groups such as families with children interested in dining may be provided incentives to a family-dining-style restaurant, whereas groups of adults may be provided coupons to restaurants that serve alcohol.

At step 630, the venue participant-based optimization data generator and map provider 60 determines the level of service the user has agreed to. For example, an operator may enhance venue participation for venue participants by providing different levels of service at corresponding different rates or prices in order to provide the level of service appropriate for each participant. For example, premium levels of service corresponding to receiving premium levels of information may be provided to users for an additional cost. At block 640, the network element 14, in response to the user-specific information, determines if the wireless device 10 is valid. For example, if payment is not provided, as specified in the venue-specific query, service by network element 14 may be denied at step 650. At block 660, the network element 14 registers wireless device 10 and validates the user-specific information. For example, if the wireless device 10 was previously registered during the previous day, the network element 14 determines if the user-specific information from the previous session is still valid. If the previous user-specific information is invalid, then the wireless device 10 is queried in order to update the valid user-specific information. For example, database 26 may store the user-specific information from the previous session and determine if the newly received user-specific information is more current than that stored in the database. Venue participant-based optimization data generator and map provider 60 may provide the venue-specific map data 44 to the wireless device 10 if the version of the venue-specific map data 44 stored in wireless device 10 is not a valid version. For example, the user-specific information previously received may indicate the version of the venue-specific map data 44 stored in wireless device 10. If the version of the venue-specific map data 44 is not the most current version at block 670, then the venue participant-based optimization data generator and map provider 60 may send the valid specific map data 44 to the user's wireless device 10 at block 680.

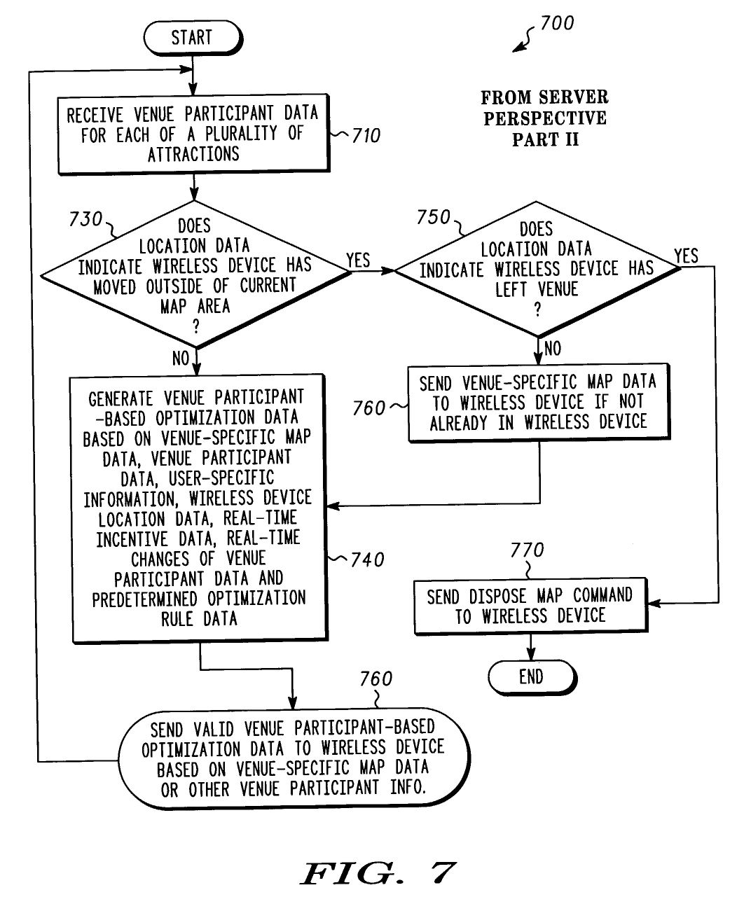

FIG. 7 is a method 700 for generating venue participant-based optimization data 42 for enhancing venue participation by venue participants. At step 710, the venue participant-based optimization data generator and map provider 60 receives venue participant data 50 from the venue participant data provider 52 for each of the attractions within the venue. The venue participant data may be information regarding the queue wait time for each attraction, such as a ride at an amusement park. Alternatively, the venue participant data 50 could be the occupancy of a restaurant in a venue such as an amusement park. As shown in block 760, the venue participant-based optimization data generator and map provider 60 sends the venue participant-based optimization data 42 to wireless device 10. The venue participant-based optimization data generator and map provider 60 sends venue-specific map data 44 based on the received wireless device location data 46. For example, the venue-specific map data 44 may be sent over as the entire map area of the venue, or as subsection map areas of the venue. As the user moves from one area of the venue to the other at blocks 730 and 750, the wireless device location data 46 informs the venue participant-based optimization data generator and map provider 60 to update the wireless device 10 with new venue-specific map data 44. As shown in block 730 and 750, if the wireless device 10 has not left the venue and has moved outside of a current map area, then the venue participant-based optimization data generator and map provider 60 may continue to dynamically send the venue participant-based optimization data 42 to the wireless device 10 at step 740.

At block 740, venue participant-based optimization data generator and map provider 60 generates venue participant-based optimization data 42 based on optimization rule information 58 and at least real-time venue participant data 50 and wireless device location data 46 as previously described. For example, the venue participant-based optimization data 42 may be generated based on the application of the optimization rule information 58, which employs an algorithm to provide information such as real-time queue wait times, directions, location information, electronic coupons based on current conditions and the status of attractions based on receiving venue participant data 50. For example, in an amusement park, if the queue wait times at one particular restaurant are high and the queue wait times at another restaurant are relatively low, then the venue participant-based optimization data generator and map provider 60 may provide electronic coupons to participants who are in the area of the restaurant with relatively low queue wait times. Alternatively, users in areas that are experiencing heavy traffic may be provided incentives to go to an area that is not as congested, by providing coupons or other suitable incentives.

As shown in block 750, if the wireless device 10 has moved outside of a current map area, then the wireless device 10 does not have valid venue-specific map data 44, and appropriate valid venue-specific map data 44 are sent to the wireless device 10 if not already in the wireless device, as shown in step 760. For example, if the wireless device 10 has moved outside of a current map area, then the venue participant-based optimization based generator and map provider 60 provides the appropriate venue-specific map data 44 from the venue-specific map database 26 in response to receiving the wireless device location data 46. As previously described, the venue participant-based optimization data generator and map provider 60 dynamically updates the venue participant-based optimization data 42 based on real-time changes of the venue participant data 50. In one exemplary embodiment, the venue is an amusement park. According to this embodiment, if one of the rides has a relatively long queue wait time, and another attraction or another ride has a relatively short queue wait time, then the venue participant-based optimization data 42 may indicate that the wait time is relatively short at the other ride, and therefore the venue participant-based optimization data generator and map provider 60 provides this information dynamically to the wireless device 10. The predetermined optimization rule 58 may be an algorithm that assesses and determines venue profitability, traffic management, event capacity, throughput, a level of service, queue length, or any optimization parameter. Any suitable optimization rule may be employed to assess and appropriately determine any suitable parameter. For example, venue profitability may be assessed by determining if any revenue generating attractions such as restaurants and shops may further increase revenue through the use of coupons. The venue participant-based optimization generator may then determine the appropriate incentives, such as coupons, in order to further enhance revenue. Traffic management may be assessed by determining if traffic is distributed evenly or at a predefined capacity level amongst attractions in the venue. Also, throughput of an attraction may be assessed by determining if each venue attraction is operating with an appropriate number of people within a unit of time, such as the number of people per hour.

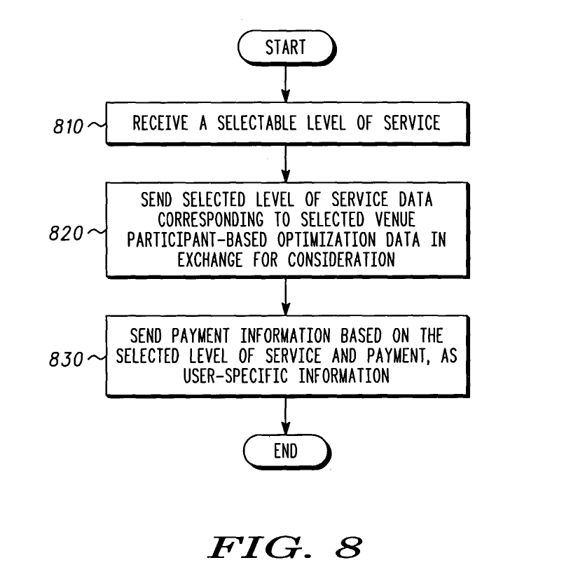

FIG. 8 is a method 800 for determining a level of service for enhancing venue participation. As shown in block 810, network element 14 sends a query to the wireless device 10 including selectable level of service data corresponding to a level of venue participant-based optimization data 42. For example, a menu may be provided to wireless device 10 in order to permit the user to select the desired level of service, such as a premium level of service. For example, a premium level of service may allow a user to obtain a limited number of premium coupons or special VIP invitations to exclusive events. According to this embodiment, the premium level of service allows a participant to receive venue participant-based optimization data 42 representing a limited number of coupons to an attraction, such as a restaurant, ride, or invitation.

In response to the query, the wireless device 10 sends selected level of service data, corresponding to a selected level of venue participant-based optimization data 42 in exchange for consideration at block 820. In one embodiment, the menu providing the selectable level of service may indicate the type of services provided, the level of detail, type of information desired and a corresponding consideration (i.e., payment) for that selected level of service. The consideration may be monetary, such as payment with a credit card, debit card, or prepaid device, or, alternatively, consideration may be complying with an incentive, such as to visit a particular attraction, restaurant, shop, etc. As shown in block 830, the wireless device 10 sends payment information in accordance with the selected level of service data in exchange for the consideration agreed to.

Although for purposes of illustration the venue discussed was described with respect to an amusement park, the venue may be any type of event or location as previously stated such as a museum, shopping mall, zoo, or any other suitable event or location. Similarly, although the wireless device 10 was discussed with reference to a mobile phone operating as a PCS and iDEN (Integrated Dispatch Enhanced Network) device that operates or that is supported by a GPS circuit and a bluetooth transceiver, any suitable communications device or protocol may be employed.

According to one embodiment, venue participant-based optimization data 42 may be dynamically transmitted from the network element 14 to the wireless device 10 via WAN 16, using text-based messaging, such as SMS (Short Message Service) to provide updates to the user on a dynamic basis such as real-time queue wait times. However, any text-based messaging service or any data transmission protocol or communication medium may be used to transmit the venue participant-based optimization data 42.

Other embodiments for the method and system described are contemplated. For example, the venue participant-based optimization data 42 may be represented by and according to any type of visual attribute such as any color, combination of colors, flashing colors, patterns, or designs.

The method and system 8 for enhancing venue participation by venue participants may benefit participants by providing them venue information regarding the queue wait times for various attractions, such as rides, and incentive data, such as coupons to restaurants and shops. The venue participant-based optimization data 42 provides valuable information about the venue to the participants to permit the participant to identify the attractions, shops, and restaurants that are of most interest, thereby providing the participants with the maximum enjoyment of the venue. Additionally, the operator of the system 8 may optimize any parameter desired such as maximizing revenue or traffic flow as desired. Accordingly, the system 8 may provide the participants real-time information such as wait time queues, directions to a venue attraction, location information and electronic coupons, that would be useful and beneficial to both operators and participants during the participants visit to the venue.

It should be understood that the implementation of other variations and modifications of the invention and its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

We claim:

1. A wireless device for enhancing venue participation by venue participants, the wireless device including a display, the wireless device comprising:
a controller operative to receive venue participant-based optimization data and venue-specific map data, wherein the venue participant-based optimization data is associated with at least the venue-specific map data, and wherein the venue-specific map data is associated with at least wireless device location data, the controller also operative to display the venue participant-based optimization data and the venue-specific map data on the display.

2. The wireless device according to claim 1 wherein the controller dynamically updates the venue participant-based optimization data, that is displayed, based on real-time changes of venue participant data while the venue-specific map data is not updated on the display.

3. The wireless device according to claim 1 wherein the venue participant-based optimization data represents real-time incentive data displayed on the display to affect participant traffic flow within a venue.

4. The wireless device according to claim 1 wherein the controller causes the venue participant-based optimization data and the venue-specific map data to be displayed in accordance with at least one of: the venue participant-based optimization data and the venue-specific map data are displayed separately on the display, the venue participant-based optimization data and the venue-specific map data appear superimposed on the display; and the venue participant-based optimization data and the venue-specific map data periodically alternate on the display.

5. The wireless device according to claim 1 wherein the controller receives at least one of: a user-initiated dispose map command, and a dispose map command from a network element for indicating whether the venue participant-based optimization data and the venue-specific map data should be disposed.

6. The wireless device according to claim 1 wherein the controller causes the venue participant-based optimization data to be displayed according to a plurality of visual attributes, wherein each of the plurality of visual attributes corresponds to a different venue activity, and wherein the visual attributes include at least one of colors, patterns, and designs.

7. The wireless device according to claim 1 wherein user-specific information is selected from the group consisting of user identification data, length of stay data, number in party data, ages of members data, event preference data, demographics data, venue-specific map data, software version data, base software engine version data, payment method data and security identification data, wherein the controller provides user-specific information for a network element to facilitate generation of user-specific venue participant based optimization data.

8. The wireless device according to claim 1 including:
at least one of a wireless local access network transceiver, and a wireless wide area network transceiver coupled to the controller, and wherein the venue-specific map data is selected from the group consisting of: amusement park map data, museum map data, convention center map data, zoo map data, and campus map data, and wherein the venue participant-based optimization data is selected from the group consisting of: delayed queue wait time data, real-time queue wait time data, direction data, location data, traffic data, coupon data, advertising data, emergency message data, venue attraction data, and wherein the venue participant-based optimization data is presented as a sound.

9. The wireless device of claim 1 wherein the controller includes at least one processing device, the wireless device including:
memory having stored therein instructions executable by the at least one processing device that causes the at least one processing device to:
receive venue participant-based optimization data, and venue-specific map data, wherein the venue participant-based optimization data is associated with at least the venue-specific map data, and wherein the venue-specific map data is associated with at least wireless device location data, the controller is also operative to display the venue participant-based optimization data and the venue-specific map data on the display.

10. A network element for enhancing venue participation by venue participants comprising:
a venue participant-based optimization data generator that utilizes optimization rule information to generate venue participant-based optimization data based on at least real-time venue participant data and wireless device location data, wherein the venue participant-based optimization data generator determines venue-specific map data based on received wireless device location data, and that sends the venue-specific map data to a wireless device for display by the wireless device.

11. The network element of claim 10 wherein:
the venue participant-based optimization data generator sends venue-specific map data to the wireless device if the wireless device has moved outside of a current map area and the wireless device does not have the valid venue-specific map data;
the venue participant-based optimization data generator sends venue participant-based optimization data to the wireless device if the wireless device has not left the venue.

12. A method for enhancing venue participation by venue participants, the method comprising:
receiving, by a wireless device, venue-specific map data, wherein the venue-specific map data is associated with at least wireless device location data;
receiving, by the wireless device, venue participant-based optimization data, wherein the venue participant-based optimization data is associated with the venue-specific map data; and
displaying the venue-specific map data and the venue participant-based optimization data.

13. The method according to claim 12 including dynamically updating the venue participant-based optimization data, that is displayed, based on real-time changes of venue participant data, while the venue-specific map data is not updated on the display.

14. The method according to claim 12 wherein the venue participant-based optimization data represents real-time incentive data displayed on the display to affect participant traffic flow within a venue.

15. The method according to claim 12 including displaying the venue participant-based optimization data and the venue-specific map data in accordance with at least one of: displaying the venue participant-based optimization data and the venue-specific map data separately, displaying the venue participant-based optimization data and the venue-specific map data appear superimposed on the display; displaying the venue participant-based optimization data and the venue-specific map data periodically alternating on the display, and presenting the venue participant-based optimization data as sound.

16. The method according to claim 12 including receiving at least one of: a user-initiated dispose map command, and a dispose map command from a network element, for indicating whether the venue participant-based optimization data and venue-specific map data should be disposed.

17. The method according to claim 12 including displaying the venue participant-based optimization data according to a plurality of visual attributes, wherein each visual attribute corresponds to a different venue activity, and wherein the visual attributes include at least one of colors, patterns, and designs.

18. The method according to claim 12 wherein user-specific information is selected from the group consisting of user identification data, length of stay data, number in party data, ages of members data, event preference data, demographics data, venue-specific map data, software version data, base software engine version data, payment method data and security identification data, the method including providing user-specific information for a network element to facilitate generation of user-specific venue participant-based optimization data.

19. The method according to claim 12 comprising:
receiving a venue-specific query for user-specific information;
presenting the venue-specific query for user-specific information to a display;
sending user-specific information in response to the venue-specific query;
sending wireless device location data in response to receiving the venue-specific query;
updating a storage device with the venue-specific map data if the storage device does not have valid venue-specific map data;
updating the storage device with the venue participant-based optimization data if the storage device does not have valid venue participant-based optimization data;
displaying the venue participant-based optimization data and the venue-specific map data in accordance with at least one of: displaying the venue participant-based optimization data and the venue-specific map data separately, the venue participant-based optimization data and the venue-specific map data appear superimposed on the display; and the venue participant-based optimization data and the venue-specific map data periodically alternate on the display; and
disposing of the venue participant-based optimization data and the venue-specific map data based on receiving at least one of: a user-initiated dispose map command, and a dispose map command from a network element.

20. The method according to claim 12, wherein:
the venue-specific map data is selected from the group consisting of: amusement park map data, museum map data, convention center map data, zoo map data, and campus map data, and
the venue participant-based optimization data is selected from the group consisting of: delayed queue wait time data, real-time queue wait time data, direction data, location data, traffic data, coupon data, advertising data, emergency message data, and venue attraction data.

21. A method for generating venue participant-based optimization data for enhancing venue participation by venue participants comprising:
sending venue-specific map data based on received wireless device location data;
generating venue participant-based optimization data based on optimization rule information, at least real-time venue participant data and wireless device location data; and
sending the venue participant-based optimization data to a wireless device.

22. The method of claim 21 comprising:
sending venue participant-based optimization data to the wireless device if the wireless device has not left the venue; and
sending valid venue-specific map data to the wireless device if the wireless device has moved outside of a current map area and the wireless device does not have the valid venue-specific map data.

23. The method of claim 21 including dynamically updating the venue participant-based optimization data based on real-time changes of venue participant data.

24. The method of claim 21 wherein the predetermined optimization rule assesses and determines at least one of: venue profitability, traffic management, event capacity, throughput, a level of service, and queue length.

25. The method of claim 21 comprising:
sending selectable level of service data to a wireless device corresponding to a level of venue participant-based optimization data;
receiving a selected level of service data corresponding to the selected level of venue participant-based optimization data; and
sending the venue participant-based optimization data in accordance with the selected level of service data in exchange for consideration.
